(19) United States
(12) Patent Application Publication
(10) Pub. No.: US 2008/0070216 A1
(43) Pub. Date: Mar. 20, 2008

(54) Book having audio information

(76) Inventors: James Becker, Bellevue, WA (US); Andy Mayer, Woodinville, WA (US)

Correspondence Address: John M. Janeway;GRAYBEAL JACKSON HALEY LLP, Suite 350, 155 - 108th Avenue NE, Bellevue, WA, 98004-5973, US

(21) Appl. No.: 11/524,627

(22) Filed: Sep. 20, 2006

(51) Int. Cl. G09B 5/00

(52) U.S. Cl. 434/317

(57) ABSTRACT

In one aspect of the invention, a book comprises at least one page visually displaying information about a subject, wherein the visually displayed information is conveyed from a first perspective; and an audio device operable to aurally display information about the subject, wherein the aurally displayed information is conveyed from a second perspective that is different than the first perspective, and wherein the information displayed aurally is different than the information displayed visually. By receiving different information from different perspectives, a user of the book can draw more and better inferences, develop more thorough conclusions and thus better understand the subject of the book.

### BACKGROUND

Many books provide a reader information about one or more subjects via text. Often the text discussing a specific subject in the book is written by one individual (the author), and thus the information provided has been organized, combined, structured and filtered through a single source—the author. For example, a novel is typically written by a single author, and how the characters perceive and act in the novel depends largely on the author's perceptions, experiences and biases. As another example, a text book is often written by several authors, each writing a chapter on a specific subject that they are very knowledgeable in, and an editor or arranger who combines the chapters into a book discussing a subject that encompasses the subjects of the chapters. The information provided in each chapter, again, depends largely on the author's perceptions, experiences and biases.

Unfortunately, most text is written by a single author because writing a text collaboratively often causes the text to lose focus on the subject or information, and thus, become difficult for the reader to follow. Because most text is written by a single author the reader only receives the information that the single author considers worth conveying.

Other books provide a reader with an audio component to supplement the information expressed in text. For example, children's books often have an audio component that says the words written on the page and that can be operated by the child. Other examples include books that have an audio component to provide sound effects, such as POW! or KABOOM!!

Unfortunately, the audio components of these books often aurally express the same or similar information that is expressed by the text. The audio components of these books typically do not provide information that is different than the information provided by the book's text.

### SUMMARY

In one aspect of the invention, a book comprises at least one page visually displaying information about a subject, wherein the visually displayed information is conveyed from a first perspective; and an audio device operable to aurally display information about the subject, wherein the aurally displayed information is conveyed from a second perspective that is different than the first perspective, and wherein the information displayed aurally is different than the information displayed visually. By receiving different information from different perspectives, a user of the book can draw more and better inferences, develop more thorough conclusions and thus better understand the subject of the book.

### BRIEF DESCRIPTION OF THE FIGURES

FIG. 1 is a perspective view of a book according to an embodiment of the invention.

FIG. 2 is a view of two, sequential pages included in the book of FIG. 1, according to an embodiment of the invention.

FIG. 3 is a view of another two, sequential pages included in the book of FIG. 1, according to an embodiment of the invention.

FIG. 4 is a view of an audio device included in the book of FIG. 1, according to an embodiment of the invention.

FIG. 5 is a schematic view of a switch included in the audio device of FIG. 4, according to an embodiment of the invention.

FIG. 6 is a view of two, sequential pages according to another embodiment of the invention.

### DETAILED DESCRIPTION

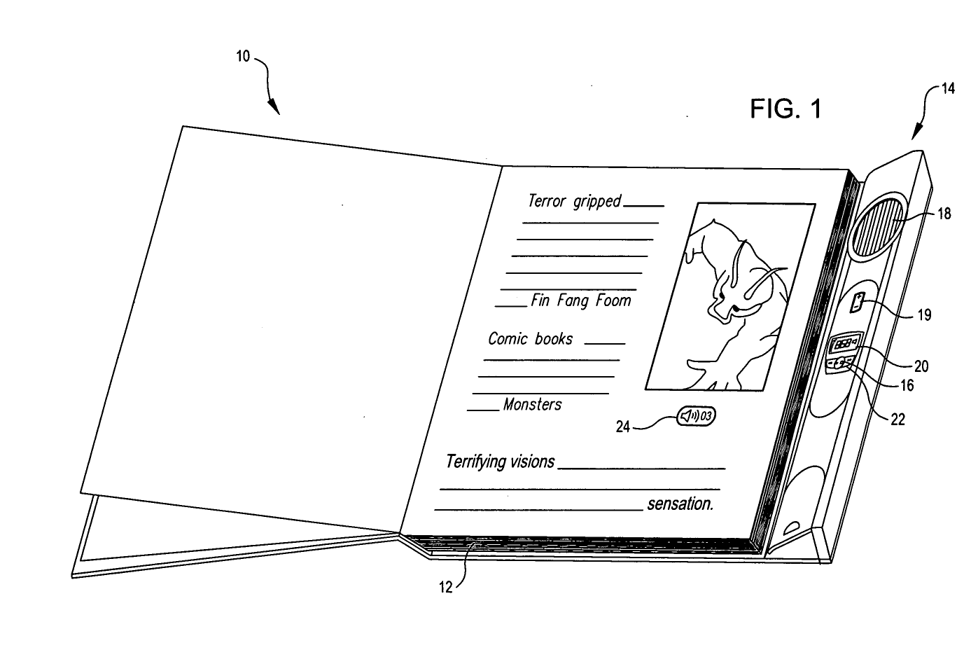

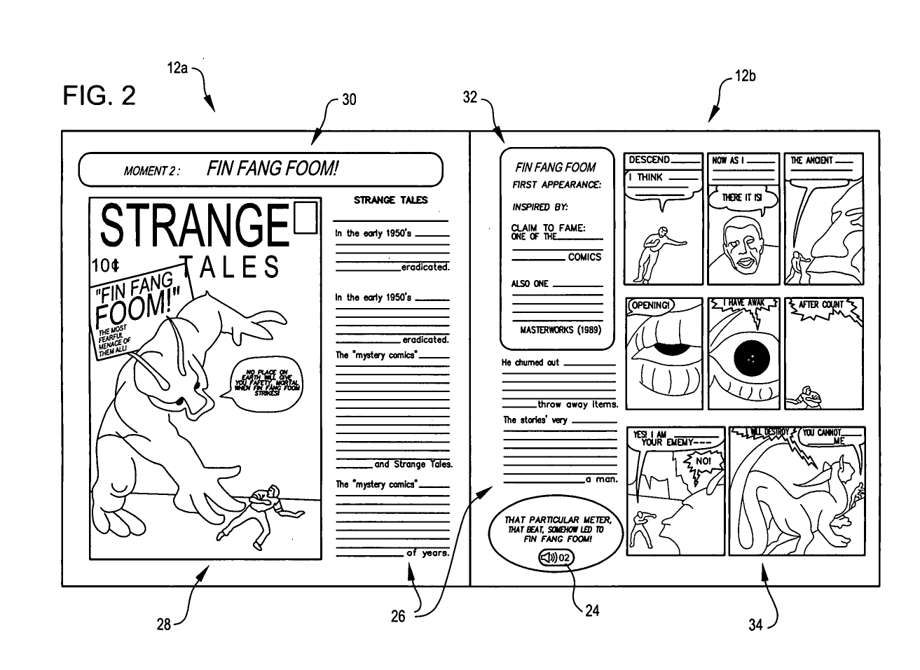

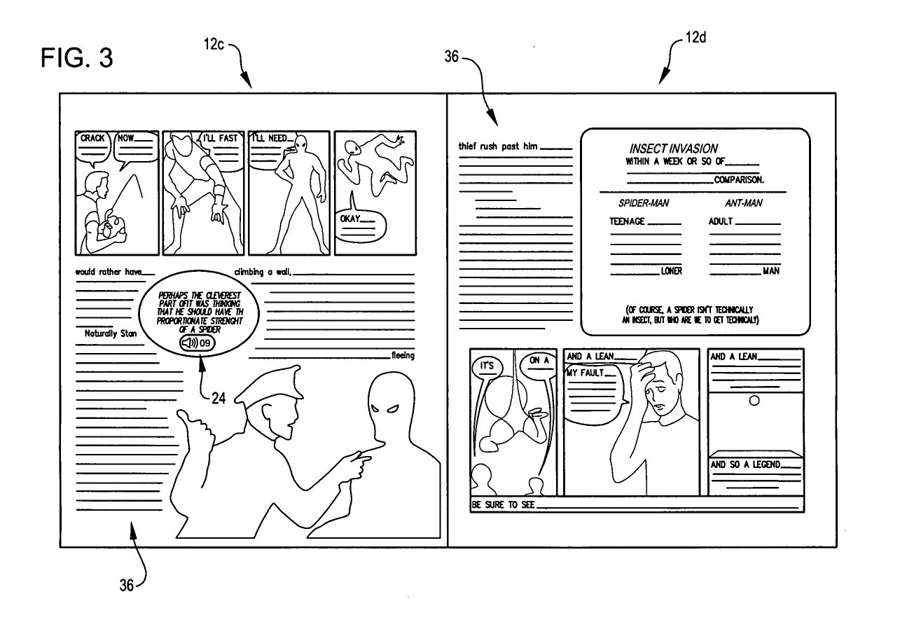

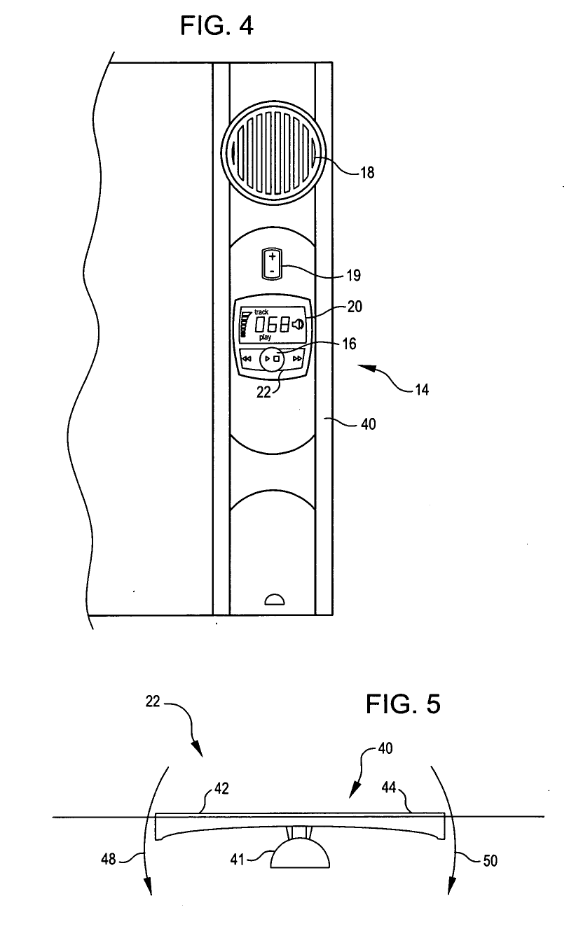

FIG. 1 is a perspective view of a book 10 according to an embodiment of the invention. The book 10 includes a page 12 (discussed in greater detail in conjunction with FIGS. 2 and 3) that visually displays information about a subject of the book, and an audio device 14 (discussed in greater detail in conjunction with FIGS. 4 and 5) that aurally displays information about the same subject. The book 10 includes 200 pages of which only 5 are shown in FIGS. 1, 2 and 3; the remainder of the pages have been omitted for clarity. The visually displayed information is conveyed from a first perspective, and the aurally displayed information is conveyed from a second perspective that is different than the first perspective. Furthermore, the visually displayed information is different than the aurally displayed information. By receiving different information from different perspectives, a user of the book can draw more and better inferences, develop more thorough conclusions, and thus, better understand the subject of the book.

The subject of the book 10 can be any desired subject. The information displayed visually can be any desired information about the subject. The information displayed aurally can be any desired information provided that it is different than the information displayed visually. And, the first and second perspectives can each be any desired perspective provided that the first perspective is different than the second perspective. For example, in this embodiment of the book 10, the subject of the book is Marvel Comics and some important moments in Marvel's history. The visually displayed information includes text written by Mr. Thomas, and illustrations of some pages and, panels or frames, of some of Marvel's comic books. The information provided by the text is provided from the third-person literary point-of-view and includes objective information describing the comic book industry, some of Marvel's employees and their deeds, and some of Marvel's comic book stories and characters. The aurally displayed information includes Stan Lee's commentary describing his personal experiences working for Marvel and creating new characters and stories. Stan Lee's commentary includes how he created and developed a character and/or a story, and why he liked or disliked a character or story. The information provided by Stan Lee's commentary is provided from the first-person literary point-of-view and includes subjective information such as Mr. Lee's perceptions, beliefs and/or thoughts.

With Marvel Comics and some important moments in Marvel's history presented to a user via a visual display and an aural display where information is conveyed from a different perspective, the book 10 can provide a user a general, objective idea of an aspect of the Comic book industry while also providing the user a specific, subjective idea of a related aspect of the comic book industry.

The audio device 14 includes any desired components that allow the device 14 to aurally display information about the subject of the book 10. For example in this and certain other embodiments of the device 14, the device 14 includes circuitry (not shown) for storing audio data, reading audio data and generating sound from the audio data, which are typically organized into one or more units or tracks. The device 14 also includes a power/play/stop switch 16 to control power to the circuitry, a speaker 18 to generate audible sounds to aurally display information, a volume switch 19 to increase or decrease the volume of the audible sounds, a display 20 to show which track is currently being aurally displayed, and a switch 22 to select a desired audio track.

In other embodiments of the book 10, one or more pages 12 may include any desired device that triggers the audio device 14 to select and play one or more units or tracks of audio data without the user having to operate the switch 22 and or switch 16. For example the triggering device can be located in a respective page and can trigger the audio device 14 when the page containing the triggering device is moved relative to the audio device 14. In some of these embodiments, the audio device 14 may not include the switch 22, or the display 20.

The page 12 may include a symbol 24 to indicate which audio track corresponds to the information visually displayed on the page 12. If there is no information to be aurally displayed that corresponds with the information visually displayed on a page, then the page 12 will not show the symbol 24. The symbol 24 can be any desired symbol that conveys to the user which audio track will provide information that corresponds with the information visually displayed on the page 12 when the circuitry reads the audio data in the audio track and generates sound from the data. For example, in this and certain other embodiments, the symbol 24 is an icon that includes a schematic of an audio speaker adjacent a number. The number corresponds to the identification label of a track stored in the device's memory and suggests to a user that the audio track labeled with the same number contains information to be aurally displayed which is related to the information displayed visually.

To operate the book 10 according to an embodiment of the invention, a user opens the book to a desired page 12 and perceives some or all of the information visually displayed on the page 12 by looking at one or more illustrations (if included on the page 12) and/or reading some or all of the text (if included on the page 12). The user also perceives the symbol 24 (if included on the page 12). Then, the user turns on the audio device 14 (if off) by exerting pressure on the switch 16. Next, the user searches for the audio track identified by the symbol 24 on the page 12 by exerting pressure on a region of the switch 22 to scroll the list of audio tracks stored in the circuitry of the device 14. When the desired audio track is displayed on the display 20, the user then selects the audio track by exerting pressure on the switch 16. The circuitry of the device 14 then reads the data comprising the desired audio track, and generates sounds from the data, which comprise the aurally displayed information. The user then hears the information aurally displayed. Once the user is satisfied with the information that he/she perceives visually and aurally, the user then turns the page 12, if desired, to perceive the visually displayed information (if included) on the next page 12 and the aurally displayed information (if included) that corresponds to the symbol 24 (if included) on the next page 12.

In other embodiments, a user may perceive the information displayed visually and aurally in another sequence. For example, the user might first perceive the symbol 24 on the page 12, search for and select the corresponding audio track. After hearing some or all of the audio track, the user might then perceive some or all of the information displayed visually on the page 12. In another example, the user might perceive the visually and aurally displayed information at the same time. In other embodiments, the user may perceive the information visually displayed on a page and hear the aurally displayed information that corresponds to another page.

FIG. 2 is a view of two, sequential pages 12a and 12b included in the book 10 of FIG. 1, according to an embodiment of the invention. The two pages 12a and 12b visually display information about Marvel Comics and an important moment in Marvel's history, the introduction and production of Fin Fang Foom.

The visually displayed information can be visually displayed using any desired form, such as an image, text or any combination of both. The image can exist in any desired form, such as an illustration, photograph, graphic design, three dimensional sculpture, three-dimensional pop-up piece, or light projection. For example, in this and certain other embodiments the visually displayed information is displayed in five regions 26, 28, 30, 32 and 34. Three of the regions 26, 30 and 32 contain text, and four of the regions 28, 30, 32 and 34 contain an image. The text and image in region 30 identifies the introduction and production of Fin Fang Foom. The text and image in region 32 provides odd facts about Fin Fang Foom, the character and comic book. The image in region 28 is copy of a comic book cover featuring Fin Fang Foom, and the image in region 34 is a copy of a series of panels from a comic book featuring Fin Fang Foom.

The text in region 26 briefly and objectively describes, from the third-person literary point-of-view, the comic book industry and Marvel Comics at the time Fin Fang Foom was introduced. The text in region 26 is printed below.
“In the early 1950s, when the so-called “horror comics” were in vogue, Timely/Marvel published a whole slew of them. It was the Marti Goodman axiom in action: find out what's selling, and crank out ten of them. When horror comics were outlawed in 1954-1955 by the new Comics Code Authority, the handful of surviving titles in the genre mutated into what came to be called “mystery comics,” because although they might contain elements of science fiction and the supernatural, the “horror” content had been mostly eradicated.
The “mystery comics” not only lacked the horror element; they also lacked distinction. Some new gimmick was needed to make them stand out on newsstands. That gimmick turned out to be: the Godzilla factor! In 1952, a popular revival of the 1933 giant-gorilla film King Kong had led to a rash of giant-monster movies, the most popular being the Japanese import Godzilla. And so began a virtual plethora of gargantuan monsters as the cover stars of Timely's comics, which had titles like Journey into Mystery, Tales to Astonish, Tales of Suspense, and Strange Tales.
Around the same time, happily, a new and important element entered the mixture: Jack Kirby. Kirby hadn't worked for Timely since he and Joe Simon had left for DC Comics in 1941, following a dispute over moonlighting and profit sharing on Captain America Comics. Now Jack was back, and his dynamic style of art and storytelling was perfect for the new Godzilla-inspired approach. Over the next couple of years he churned out dozens of such stories, from ideas and scripts by editor Stan Lee. When Stan got busier, he turned the scripting chores over to his young brother, Larry Lieber. Neither writer bothered to sign these stories, which to them seemed like throwaway items.
The stories' very names are a litany of the imaginatively interchangeable: “Groot! The Monster from Planet X!” “Gruto!” “The Glob!” “The Glop!” “Googam, Son of Goom!” “Sporr! The Thing That Could Not Die!” “Gigantus! The Monster That Walked Like a Man!”
And then there was “Fin Fang Foom!”

The page 12b also includes a symbol 24 to indicate which audio track corresponds to the information visually displayed in the regions 26-34. The audio track includes Stan Lee's commentary describing how he created Fin Fang Foom's name, and thus provides information that is different than the information visually displayed by the text in region 26, and that is from a different perspective. The audio track that contains Stan Lee's commentary is printed below.
“When I was a kid I loved going to the movies. And there was one movie I'd seen, I remember nothing about it except the name. Those three words just stuck in my memory—Chou-Chin-Chow. So when I was looking for the name of a monster, I remembered Chou-Chin-Chow . . . that particular meter, that beat somehow led to Fin-Fang-Foom. Chou-Chin-Chow . . . Fin-Fang-Foom. And that's how Fin-Fang-Foom was born.”

FIG. 3 is a view of another two, sequential pages included in the book of FIG. 1, according to an embodiment of the invention. The two pages 12c and 12d visually display information about Marvel Comics and another important moment in Marvel's history, the introduction and production of Spider Man.

The text in region 36 of pages 12c and 12d briefly and objectively describes, from the third-person literary point-of-view, the creation and development of Spider Man as a different kind of character. The text in region 26 is printed below.
“would rather have been drawing fantasy or science fiction or almost anything except guys who wore trunks over acrobat-style tights and flew through the air with the greatest of ease.
   Naturally, Stan wasn't really trying to drive away potential paying customers. The final sentence of the caption read: “But, we think you may find our SPIDERMAN just a bit . . . different!” Point taken; all those other comic book super heroes might be carbon copies of one another, but this one was going to strike out in new directions.
   Stan and Steven then proceeded, in a mere eleven pages, to completely justify that initial caption. Spider-Man's now-familiar debut reads almost like a parody of a super hero origin. A radioactive spider bites a teenager—not a pipe-smoking adult, let alone an infant from a dying planet in a far-flung galaxy. When Peter first discovers that bite has given him spider-like powers, he often looks awkward in action. Who could look graceful climbing a wall, or scrambling across an aerial cable not on two legs but on all fours?
   And what does this kid do once he realizes what has happened to him? Does he rage like the Hulk or vow to help mankind like the F.F.? No, he puts on a crude mask and wins $100 in a wrestling contest! After sewing a red-and-black costume with a mask that hides his entire face (a rarity even in super hero comics, since it hid the hero's expression), designing wrist devices that shoot out “strong liquid cement” webbing, and christening himself “Spiderman,” all he does is appear on TV for a bit of quick cash. He even lets a fleeing thief rush past him with a cop in hot pursuit, because “From now on I just look out for number one.” He promptly goes home to his uncle Ben and aunt May and revels in a new microscope they've bought him.
   This was a hero?
   Yes, according to Stan Lee.
   Spiderman” quickly becomes “the sensation of the nation” and is only brought to his senses after Uncle Ben is murdered by a burglar. Spider-Man handily captures the criminal and is stunned to recognize him as the very same thief he'd let get away days before at the TV station. Peter feels responsible for his uncle's death. The final panel of the origin shows the hero, mask off and head bowed, walking off into the night, dwarfed by the skyscrapers around him and realizing that: “In this world, with great power there must also come-great responsibility!”

The page 12c also includes a symbol 24 to indicate which audio track corresponds to the information visually displayed on pages 12c and 12d. The audio track includes Stan Lee's commentary describing his thoughts about Spider Man, and thus provides information that is different than the information visually displayed by the text in region 26, and that is from a different perspective. The audio track that contains Stan Lee's commentary is printed below.
“It seems to me since we called him Spider Man, like any good spider, he should be able to crawl on walls, he should be able to spin a web. Perhaps the cleverest part of it was thinking that he should have the proportionate strength of a spider, and I always loved that phrase, ‘the proportionate strength of a spider.’”

FIG. 4 is a view of the audio device 14 included in the book 10 of FIG. 1, according to an embodiment of the invention. The audio device 14 aurally displays information about the subject of the book 10, and may be mounted as desired to a component of the book 10. For example, in this and certain other embodiments, the audio device 14 includes a housing 40 to hold and protect the circuitry (not shown), the power/play/stop switch 16, the speaker 18, the volume switch 19, the display 20 and switch 22. The housing 40 is permanently mounted to the back cover 38 of the book 10 with adhesive to mount the device 14. In other embodiments, the audio device 14 may be mounted to the front cover (not shown) of the book 10, or to a page (not shown) disposed between the front and back covers of the book. In still other embodiments of the book 10, the audio device 14 may be releasably fastened to a component of the book 10 using any desired fastening technique that allows one to remove the device 14 from the book component and attach a different device 14 or re-attach the same device 14 to the component. For example, the device 14 may be releasably attached to the back cover 38 with Velcro.

The circuitry of the audio device 14 can be any desired circuitry capable of storing audio data, reading audio data and generating sound from the audio data. For example, in this and certain other embodiments of the device 14, the circuitry includes a conventional circuit for controlling and distributing power generated by batteries or other means. The circuitry also includes a conventional memory circuit for storing audio data, and a conventional processor circuit for reading the audio data and powering the speaker 18 to generate a sound from the data read. All or a portion of the memory circuit may be removable from the device 14 as desired, such as a memory stick that is releasably connected to a computer via a USB connector. In other embodiments, no portion of the memory circuit is removable from the device 14.

The speaker 18, power/play/stop switch 16 and display 20 each may be configured as desired. For example, in this and certain other embodiments of the device 14, the speaker is a conventional speaker, and the switch 16 is a conventional push-button switch that one pushes to provide or stop providing the circuitry power, to play a selected audio track, or to stop playing a selected audio track. If the circuitry is receiving power and an audio track is being played, then pushing the switch 16 will cause the circuitry to stop playing the audio track. If the circuitry is receiving power and an audio track is not being played, then pushing the switch 16 will cause the circuitry to play an audio track. If the circuitry is receiving power then pushing the switch 16 and holding it depressed for a longer period of time will cause the circuitry to stop receiving power. If the circuitry is not receiving power, then pushing the switch 16 will cause the circuitry to receive power. In this and certain other embodiments, the display 20 includes a conventional liquid crystal display (LCD) that displays the activity being performed by the circuitry and the track that is the subject of the activity.

Other embodiments are possible. For example, the switch 16 may be a toggle switch and the display may include a light emitting diode (LED) that displays the activity being performed by the circuitry and the track that is the subject of the activity.

FIG. 5 is a schematic view of a switch 22 included in the audio device of FIG. 4, according to an embodiment of the invention. The switch 22 is similar to the volume switch 19, and thus, the following discussion regarding the switch 22 also applies to the volume switch 19.

The switch 22 is configured to allow a user to engage the device's circuitry to perform an activity. For example, in this and certain other embodiments, the switch 22 allows a user to engage the circuitry to select a desired audio track. The switch 22 includes a body 40 that has two regions 42 and 44 that a user pushes individually to engage the circuitry to perform one of a respective two activities. To scroll through the list of audio tracks in descending order, one can push the region 42 of the body 40 in the direction shown by arrow 48. To scroll through the list of audio tracks in ascending order, one can push the region 44 of the body 40 in the direction shown by arrow 50.

Other embodiments are possible. For example, the switch 22 may be any other desired type of mechanical switch such as a dial switch. In other embodiments, the switch may be a thermal switch or an electrical switch. In still other embodiments, the switch may include two separate switch bodies that can be individually pushed. In still other embodiments, the switch may be configured to allow a user to engage the circuitry to perform more or fewer activities. For example the switch 22 may be configured to also allow a user to turn the audio device 14 on and/or off. In still other embodiments the switch 16 and switch 22 can be combined into a single switch.

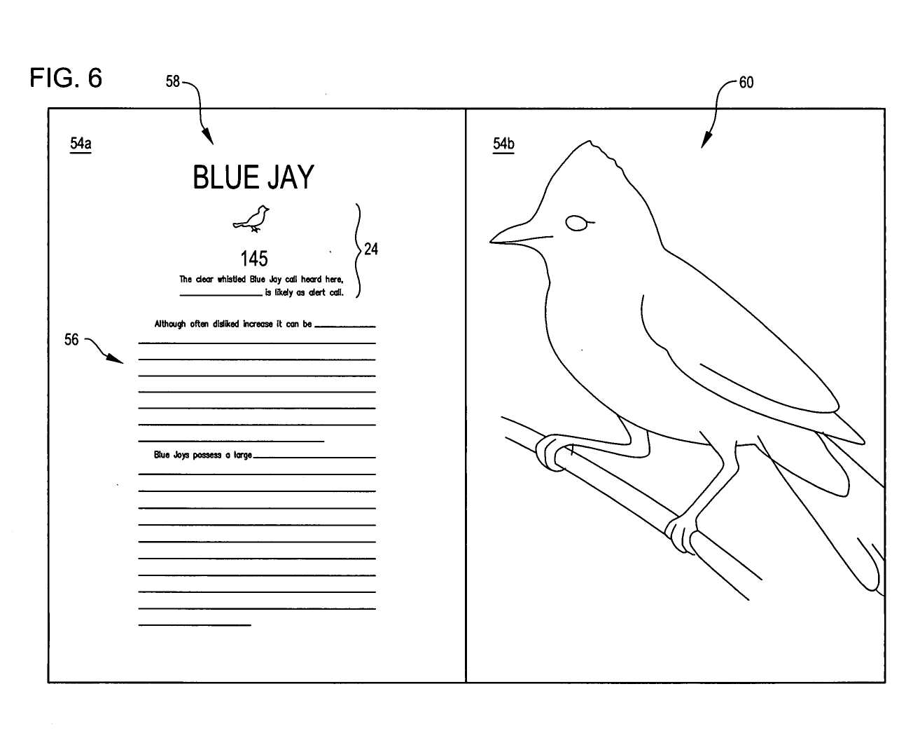

FIG. 6 is a view of two, sequential pages 54a and 54b from a book according to another embodiment of the invention. In this embodiment, some specific species of birds are the subject of the book. The visually displayed information includes text written by Mr. Les Beletsky, and illustrations of the specific species of birds discussed. The information provided by the text is provided from the third-person literary point-of-view and includes objective information describing the general characteristics of the species, their natural habitat, and one or more of their calls. The aurally displayed information includes one or more of the species' calls. The information provided by the bird calls are provided from the first-person literary point-of-view and includes subjective information such as the birds' emotion when he made the call or typically makes the call.

With objective information describing the general characteristics of the species, their natural habitat, and one or more of their calls, presented to a user via a visual display, and an aural display where information is conveyed from a different perspective, the book can provide a user a general, objective idea of some species of birds while also providing the user a specific, subjective idea of a related aspect of the birds.

In this embodiment, the two pages 54a and 54b visually display information about Blue Jays in three regions 56, 58 and 60. Two of the regions 56 and 58 contain text, and two of the regions 58 and 60 contain an image. The text and image in region 58 identifies the introduction of the Blue Jay. The image in region 60 is copy of an illustration of a Blue Jay. The text in region 56 briefly and objectively describes, from the third-person literary point-of-view, the general characteristics of the Blue Jays, their natural habitat, and four of their calls. The text in region 56 is printed below.
“Although often disliked because it can be aggressive toward other birds, the Blue Jay offers excitement and fascination to those who observe it closely. The species is a year-round resident over most of eastern North America. It prefers woodlands but it is also common in towns and residential areas, especially those having large oaks. These birds eat insects and spiders, acorns and other nuts, soft fruits, seeds, small frogs, lizards, rodents and birds, and they quickly learn to take food provided by people.
Blue Jays possess a large repertoire of calls. Each of the four described here is used in many situations. Jeers, sometimes sounding like jaay, are harsh, loud calls used for assembly and when potentially threatened by predators.

Pump-handle calls are clear, musical whistles, sometimes with harsh or gurgling overtones. Some of these, called bell calls, sound like tull-ull or twirl-ed, usually have a clear, liquid quality and serve as alarm or alert calls. Members of a pair use low-volume, guttural clucking or chucking sounds, perhaps to keep in contact. Finally, rattles are series of rapid, dry, raspy clicks, reminiscent of the loud purr of a cat, but faster and crisper.”

The page 54a also includes a symbol 24 to indicate which audio track corresponds to the information visually displayed in the regions 56-60. The audio track includes one of the pump-handled calls, and provides a user an idea of how the call actually sounds and the emotion conveyed by the bird through the call. Thus, information provided by the call is different than the information visually displayed by the text in region 56, and from a different perspective.

Other embodiments are possible, such as a book on different animals. In still other embodiments, a book may be about the movie Starwars with audio content provided by Mr. George Lucas. In still other embodiments a book may be about an event in or period of history with audio content provided by a participant in the event or by newsreel footage or some other media from the same time. For example, the subject of the book can be World War I with one perspective of the war from an English soldier in the trenches at Somme and the other perspective from a German soldier in the trenches at Somme at the same time. In still other embodiments, a book may be about natural history. In still other embodiments, a book may be a novel or artwork with audio content being another person's commentary or critique of the novel or artwork.

What is claimed is:

1. A book comprising:
at least one page visually displaying information about a subject, wherein the visually displayed information is conveyed from a first perspective; and
an audio device operable to aurally display information about the subject, wherein the aurally displayed information is conveyed from a second perspective that is different than the first perspective, and wherein the information displayed aurally is different than the information displayed visually.

2. The book of claim 1 wherein the first perspective includes at least one of the following:
a first person point of view,
a second person point of view, and
a third person point of view.

3. The book of claim 1 wherein the second perspective includes at least one of the following:
a first person point of view,
a second person point of view, and
a third person point of view.

4. The book of claim 1 wherein the subject of the information displayed includes an artist and a creation of the artist.

5. The book of claim 1 wherein the subject of the information displayed includes at least one of the following an author, playwright, film maker, architect and designer, and his/her respective creation.

6. The book of claim 1 wherein the subject of the information displayed includes a creator of a comic story and the story.

7. The book of claim 1 wherein the subject of the information displayed includes an animal and a vocal call generated by the animal.

8. The book of claim 1 wherein the subject of the information displayed includes an historical event and a person who experiences the event.

9. The book of claim 1 wherein the subject of the information displayed includes an historical event and a person who reported on the event.

10. The book of claim 1 wherein the visually displayed information is in the form of at least one of the following: text and an image.

11. The book of claim 1 wherein the aurally displayed information includes at least one of the following: a word and a sound.

12. The book of claim 1 wherein:
the visually displayed information includes:
an illustration of a comic story character,
text describing, from a third person point of view, the experiences of the comic story's creator working in the comic industry,
an icon identifying a portion of the information to be aurally displayed that corresponds with the text or illustration, and
the aurally displayed information includes the creator describing, from a first person point of view, how the character was created.

13. The book of claim 1 wherein:
the visually displayed information includes an illustration of a bird and text describing, from a third person point of view, the physical and behavioral characteristics of the bird, and
the aurally displayed information includes a vocal call that the bird makes.

14. The book of claim 1 further comprising a cover to protect the at least one page,
and to which the audio device is mounted.

15. The book of claim 1 wherein the audio device includes a circuit operable to generate the aurally displayed information.

16. The book of claim 1 wherein the audio device includes a circuit operable to generate the aurally displayed information, wherein the circuit includes:
a speaker operable to aurally display the aurally displayed information,
a memory operable to store data representing the aurally displayed information,
a processor operable to execute instructions to convert the stored data into a signal that the speaker aurally displays, and
a switch operable to select a portion of the stored data to be converted into a signal.

17. A method of conveying information in a book format, the method comprising:
visually displaying information about a subject on at least one page;
conveying the visually displayed information from a first perspective;
aurally displaying information about the subject, wherein the information aurally displayed is different than the information visually displayed; and
conveying the aurally displayed information from a second perspective that is different than the first perspective.

18. The method of claim 17 further comprising visually displaying an icon that identifies a portion of the aurally displayable information that corresponds with the visually displayed information.

19. The method of claim 18 wherein aurally displaying information includes selecting a portion of the aurally displayable information that corresponds with the visually displayed information.
